(19) United States
(12) Patent Application Publication
(10) Pub. No.: US 2021/0251724 A1
(43) Pub. Date: Aug. 19, 2021

(54) DENTAL APPLIANCE WITH METAL OXIDE COATING

(71) Applicant: 3M INNOVATIVE PROPERTIES COMPANY, St. Paul, MN (US)

(72) Inventors: Bhaskar V. Velamakanni, Woodbury, MN (US); Ta-Hua Yu, Woodbury, MN (US); Daniel J. Skamser, Ham Lake, MN (US); Narina Y. Stepanova, Woodbury, MN (US); Mitchell A. Hirsch, Woodbury, MN (US); Junkang J. Liu, Woodbury, MN (US); Carola A. Carrera Vidal, Plymouth, MN (US)

(21) Appl. No.: 17/251,873

(22) PCT Filed: Jun. 10, 2019
(86) PCT No.: PCT/IB2019/054818

§ 371 Date: Dec. 14, 2020

Related U.S. Application Data
(60) Provisional application No. 62/685,773, filed on Jun. 15, 2018.

(51) Int. Cl. A61C 7/08; A01N 59/20; A01N 59/16; A01N 25/10

(52) U.S. Cl. CPC A61C 7/08; A01N 59/20; C23C 16/40; A01N 25/10; A01N 59/16

(57) ABSTRACT

A dental appliance includes a polymeric shell with a first major surface having a plurality of cavities for receiving one or more teeth, and a layer of a metal oxide MOx on the first major surface.

### BACKGROUND

Orthodontic treatments involve repositioning misaligned teeth and improving bite configurations for improved cosmetic appearance and dental function. Repositioning teeth is accomplished by applying controlled forces to the teeth over an extended time period.

“Braces” include a variety of appliances such as brackets, bands, archwires, ligatures, and O-rings that are bonded to the teeth of a patient. The appliances are periodically replaced or adjusted by an orthodontist to apply the desired forces to the teeth and reposition them to achieve a desired alignment condition.

Teeth may also be repositioned by placing a polymeric incremental position adjustment appliance, generally referred to as an orthodontic aligner or an orthodontic aligner tray, over the teeth of the patient for each treatment stage of an orthodontic treatment. The orthodontic alignment trays include a polymeric shell with a plurality of cavities for receiving one or more teeth. The individual cavities in the polymeric shell are shaped to exert force on one or more teeth to resiliently and incrementally reposition selected teeth or groups of teeth in the upper or lower jaw. A series of orthodontic aligner trays are provided for wear by a patient sequentially and alternatingly during each stage of the orthodontic treatment to gradually reposition teeth from one tooth arrangement to a successive tooth arrangement to achieve a desired tooth alignment condition. Once the desired alignment condition is achieved, an aligner tray, or a series of aligner trays, may be used periodically or continuously in the mouth of the patient to maintain tooth alignment. In addition, orthodontic retainer trays may be used for an extended time period to maintain tooth alignment following the initial orthodontic treatment.

A stage of orthodontic treatment may require that a polymeric orthodontic retainer or aligner tray remain in the mouth of the patient for several hours a day, over an extended time period of days, weeks or even months. While the orthodontic retainer or aligner tray is in use in the mouth of the patient, foods or other substances can stain or otherwise damage the appliance. In addition, microorganisms can contaminate the surface of the appliance, which in some cases can also cause biofilms to form on the surface. The biofilms can be difficult to remove, even if the orthodontic aligner tray is periodically cleaned. Microorganisms or biofilm buildup on the surface of the orthodontic aligner tray can stain or otherwise discolor the aligner tray, can cause undesirable tastes and odors, and even potentially lead to various periodontal diseases.

Anti-microbial articles or coatings have been used to prevent/reduce infections on medical devices such as orthopedic pins, plates and implants, wound dressings, and the like. Metallic ions with anti-microbial properties, such as Ag, Au, Pt, Pd, Ir, Cu, Sn, Sb, Bi, Zn, and the like, have been used as anti-microbial compounds. Various silver salts, complexes and colloids have been used to prevent and control infection on the surfaces of medical devices. The free silver ions in soluble salts of silver can be complexed or removed from a surface, and may not provide sufficiently prolonged release of silver ions to maintain an antimicrobial effect when a dental appliance is used in the mouth of a patient for an extended time period. As a result, soluble silver salts must be reapplied periodically, and reapplication can be burdensome or impractical.

### SUMMARY

In general, the present disclosure is directed a dental appliance that includes on at least one exposed major surface an adherent, protective metal oxide (MOx) coating. In some embodiments, the MOx coating can effectively release antimicrobial agents over an extended time period to reduce or substantially prevent at least one of undesirable results of antimicrobial contamination such as, for example, unwanted odor, flavor or discoloration, which can be induced by microbial contamination of the surface, or by a biofilm formed on the surface. In some embodiments, the MOx coating can also prevent calculus build-up on the orthodontic dental appliance, or can include additives to prevent the formation of cavities in the teeth of the patient.

In some embodiments, the dental appliance is an orthodontic appliance configured for moving or retaining the position of teeth in an upper or lower jaw of a patient such as, for example, an orthodontic aligner tray or a retainer.

The present disclosure is further generally directed to methods for applying the MOx coating on an exposed major surface of the orthodontic dental appliance such as, for example, by vapor coating the MOx coating on the surface of the dental appliance. Suitable vapor coating methods include, but are not limited to, organic vapor coating, sputtering, thermal evaporation, chemical vapor deposition (CVD) and atomic layer deposition (ALD).

In one aspect, the present disclosure is directed to a dental appliance including a polymeric shell with a first major surface comprising a plurality of cavities for receiving one or more teeth; and a layer of a metal oxide MOx on the first major surface.

In another aspect, the present disclosure is directed a method of making a dental appliance, the method including: applying a layer of a transparent metal oxide MOx on at least one major surface of a substantially flat sheet of a polymeric material; and forming a plurality of cavities in the polymeric material to form the dental appliance, wherein the cavities are configured to receive one or more teeth.

In another aspect, the present disclosure is directed a method of making a dental appliance, the method including: forming a polymeric shell comprising a plurality of cavities in a first major surface thereof, wherein the cavities are configured to receive one or more teeth; and applying a layer of a transparent metal oxide MOx on the first major surface of the polymeric shell to form the dental appliance.

In another aspect, the present disclosure is directed to a dental appliance, including: a polymeric shell with a first major surface with a plurality of cavities for receiving one or more teeth; and a transparent metal oxide MOx adhered to the first major surface and forming a substantially continuous layer thereon, wherein the transparent metal oxide MOx penetrates below the first major surface.

In another aspect, the present disclosure is directed to a method of making a dental appliance, the method including: applying by plasma enhanced chemical vapor deposition a substantially continuous layer of a transparent metal oxide MOx over at least 95% of the first major surface of a substantially flat sheet of a polymeric material, wherein the transparent metal oxide MOx penetrates below the first major surface; and thermally forming a plurality of cavities in the first major surface of the polymeric material, wherein the cavities are configured to receive one or more teeth.

In another aspect, the present disclosure is directed to a method of orthodontic treatment, including: positioning a dental appliance around one or more teeth, wherein the dental appliance includes: a polymeric shell with a first major surface comprising a plurality of cavities for receiving the one or more teeth, and a layer of a transparent metal oxide MOx on the first major surface of the polymeric shell.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a schematic overhead perspective view of a dental alignment tray.

FIG. 2 is a schematic overhead perspective view of a method for using a dental alignment tray by placing the dental alignment tray to overlie teeth.

FIGS. 3A-3C are photographs of surface morphology and composition of AgOx, ZnO and AgCuZnOx coatings on PETg film as described in Examples 1-3.

Like symbols in the drawings indicate like elements.

### DETAILED DESCRIPTION

In one aspect, an orthodontic appliance 100 as shown in FIG. 1, which is also referred to herein as an orthodontic aligner tray, includes a thin polymeric shell 102 having a plurality of cavities 104 shaped to receive and resiliently reposition one or more teeth from one tooth arrangement to a successive tooth arrangement. Or, in the case of a retainer tray the thin polymeric shell 102 having a plurality of cavities 104 are shaped to receive and maintain the position of the previously realigned one or more teeth. The polymeric shell 102 includes cavities 104 configured to fit over one or more of the teeth present in the upper or lower jaw of a patient.

The shell 102 of the orthodontic appliance 100 is an elastic polymeric material that generally conforms to a patient's teeth, and may be transparent, translucent, or opaque. In some embodiments, the shell 102 is a clear or substantially transparent polymeric material that may include, for example, one or more of amorphous thermoplastic polymers, semi-crystalline thermoplastic polymers and transparent thermoplastic polymers chosen from polycarbonate, thermoplastic polyurethane, acrylic, polysulfone, polyprolylene, polypropylene/ethylene copolymer, cyclic olefin polymer/copolymer, poly-4-methyl-1-pentene or polyester/polycarbonate copolymer, styrenic polymeric materials, polyamide, polymethylpentene, polyetheretherketone and combinations thereof. In another embodiment, the shell 102 may be chosen from clear or substantially transparent semi-crystalline thermoplastic, crystalline thermoplastics and composites, such as polyamide, polyethylene terephthalate polybutylene terephthalate, polyester/polycarbonate copolymer, polyolefin, cyclic olefin polymer, styrenic copolymer, polyetherimide, polyetheretherketone, polyethersulfone, polytrimethylene terephthalate, and mixtures and combinations thereof. In some embodiments, the shell 102 is a polymeric material chosen from polyethylene terephthalate, polyethylene terephthalate glycol, polycyclohexylenedimethylene terephthalate glycol, and mixtures and combinations thereof. One example of a commercially available material suitable as the elastic polymeric material for the shell 102, which is not intended to be limiting, is PETg. Suitable PETg resins can be obtained from various commercial suppliers such as, for example, Eastman Chemical. Kingsport, Tenn.; SK Chemicals, Irvine, Calif.; DowDuPont, Midland, Mich.; Pacur, Oshkosh, Wis., and Scheu Dental Tech, Iserlohn, Germany.

In some embodiments, the shell 102 may be made of a single polymeric material, or may include multiple layers of different polymeric materials.

In one embodiment, the shell 102 is a substantially transparent polymeric material. In this application the term substantially transparent refers to materials that pass light in the wavelength region sensitive to the human eye (about 400 nm to about 750 nm) while rejecting light in other regions of the electromagnetic spectrum. In some embodiments, the reflective edge of the polymeric material selected for the shell 102 should be above about 750 nm, just out of the sensitivity of the human eye.

The first major external surface 106 of the shell 102, or a second major internal surface 108 of the shell 102 that contacts the teeth of the patient, or both, include a layer 110 of a biocompatible metal oxide (MOx).

In some embodiments, the metal oxide layer 110 is substantially transparent to visible light of about 400 nm to about 750 nm when applied at a thickness of about 1 nm to about 200 nm on a substantially transparent shell 102. In various embodiments, the visible light transmission through the combined thickness of the shell 102 and the antimicrobial metal oxide layer 110 is at least about 50%, or about 75%, or about 85%, or about 90%, or about 95%.

In some embodiments, the antimicrobial metal oxide layer 110 can optionally include dyes or pigments to provide a desired color that may be, for example, decorative or selected to improve the appearance of the teeth of the patient.

The metal oxide used in the metal oxide layer 110 can include, but is not limited to, silver oxide, copper oxide, gold oxide, zinc oxide, magnesium oxide, titanium oxide, chromium oxide, and mixtures, alloys and combinations thereof. In some embodiments, which are not intended to be limiting, the metal oxide in the metal oxide layer 110 is chosen from AgCuZnOx, Ag doped ZnOx, Ag doped AZO, Ag doped TiO₂, Al doped ZnO, and TiOx.

In some embodiments, the biocompatible MOx coating can have at least one of an anti-microbial, an antibacterial, or an anti-biofilm, effect. A wide variety of metal oxides MOx may be used in such an application, as long as the layer 110 exhibits at least a 1-log microbial reduction against S. aureus and S. mutans following 24 hour contact. In some embodiments, the metal oxide layer 110 has at least a 2-log microbial reduction against S. aureus and S. mutans following 24 hour contact. In some embodiments, the metal oxide layer 110 has at least a 3-log microbial reduction against S. aureus and S. mutans following 24 hour contact. In some embodiments, the metal oxide layer 110 has at least a 4-log microbial reduction against S. aureus and S. mutans following 24 hour contact.

Log reductions are measured after testing according to ISO test method ISO 22196:2011, “Measurement of antibacterial activity on plastics and other non-porous surfaces,” with appropriate modifications of the test method to accommodate the test materials.

The metal oxide layer 110 can include any antimicrobially effective amount of metal oxide MOx. In various embodiments, which are not intended to be limiting, the metal oxide layer 110 can include less than 100 mg, less than 40 mg, less than 20 mg, or less than 5 mg MOx per 100 cm.

The metal oxide layer 110 can be formed on the surfaces 106, 108 of the shell 102 by any suitable means, for example, by physical vapor deposition techniques. The physical vapor deposition techniques can include, but are not limited to, vacuum or are evaporation, sputtering, magnetron sputtering and ion plating. Suitable physical vapor deposition techniques can include those described in U.S. Pat. Nos. 4,364,995, 5,681,575 and 5,753,251, and PCT publications: WO201875259, WO201783482, WO201783166, WO201704231, US patent application US20180093008, the disclosures of which are hereby incorporated by reference.

By the controlled introduction of reactive material, for example, oxygen, into the metal vapor stream of vapor deposition apparatus during the vapor deposition of metals onto substrates, controlled conversion of the metal to metal oxides can be achieved. Therefore, by controlling the amount of the reactive vapor or gas introduced, the proportion of metal to metal oxide in the metal oxide layer can be controlled. For 100% conversion of the metal to metal oxides at a given level of the metal oxide layer 110, at least a stoichiometric amount of the oxygen containing gas or vapor is introduced to a portion of the metal vapor stream. When the amount of the oxygen containing gas increases, the metal oxide layer 110 will contain a higher weight percent of metal oxide. The amount of oxygen-containing gas can be used to control the release of metal atoms, ions, molecules or clusters on a sustainable basis. As the amount of metal oxide increases when the level of oxygen containing gas introduced into the deposition chamber increases, metal ions released from the article in turn increases. Thus, a higher weight percent of metal oxide can, for example, provide an enhanced release of anti-microbial agents, such as metal ions and provide an increased anti-microbial activity for the metal oxide layer 110.

The metal oxide layer 110 can be formed as a thin film. In antimicrobial applications, the film can have a thickness no greater than needed to provide release of metal ions on a sustainable basis over a suitable period of time. In that respect, the thickness will vary with the particular metal in the coating (which varies the solubility and abrasion resistance), and with the amount of the oxygen containing gas or vapor introduced to the metal vapor stream. The thickness will be sufficiently thin that the metal oxide layer does not interfere with the dimensional tolerances or flexibility of the shell 102. Typically, the metal oxide layer has a thickness of less than 1 micron, but increased thicknesses may be used depending on the degree of metal ion release needed over a period of time. In various embodiments, the metal oxide layer 110 has a thickness of about 1 nm to about 200 nm, or about 5 nm to about 85 nm, or about 10 nm to about 50 nm, or about 25 nm to about 40 nm.

In some embodiments, the metal oxide layer can optionally include additional metal compounds such as silver chloride, silver bromide, silver iodide, silver fluoride, copper halide, zinc halide, and combinations thereof.

Additional additives in the metal oxide layer include, but are not limited to, calcium, phosphate, and magnesium compounds, and combinations thereof.

In some embodiments, the antimicrobial effect of the layer 110 occurs, for example, when the orthodontic article 100 is brought into contact with an alcohol or a water-based electrolyte such as a body fluid or body tissue in the mouth of the patient, thus releasing metal ions such as, for example, Ag+, atoms, molecules or clusters. The concentration of the metal which is needed to produce an anti-microbial effect will vary from metal to metal in the metal oxide coating 110. Generally, anti-microbial effect is achieved in body fluids such as saliva, plasma, serum or urine at concentrations less than 10 ppm. In some embodiments, Ag+ release concentration from the article can be 0.1 ppm, 0.5 ppm, 1 ppm, 2 ppm, 2.5 ppm, 3 ppm, 4 ppm, 5 ppm, 6 ppm, 7 ppm, 8 ppm, 9 ppm, 10 ppm, 20 ppm, 40 ppm or a range between and including any two of these values.

When the amount of metal oxide m the metal oxide layer 110 is increased, the metal ions released from the article in turn increases. In one example, which is not intended to be limiting, a more than 50 wt % metal oxide layer, or more than 60 wt. %, or more than 70 wt. %, or more than 80 wt %, or more than 90 wt. %, provides an enhanced release of metal ions from the article, and can provide a very effective anti-microbial effect.

The orthodontic appliance 100 may be made using a wide variety of techniques. In one embodiment, a layer of a transparent metal oxide MOx is applied on one or both major surfaces of a substantially flat sheet of a polymeric material. In various embodiments, the layer of the transparent metal oxide is applied by one of sputtering, physical vapor deposition, chemical vapor deposition, electronic beam deposition, and combinations thereof. In some embodiments, the layer of the transparent metal oxide is applied by plasma enhanced chemical vapor deposition. The major surface of the polymeric sheet to which the MOx layer is applied may optionally be chemically or mechanically treated prior to applying the layer of the transparent metal oxide to, for example, enhance adhesion between the metal oxide layer and the substrate.

A plurality of cavities may then be formed in the sheet of polymeric material to form an orthodontic appliance, wherein the cavities are configured to receive one or more teeth. The cavities may be formed by any suitable technique, including thermoforming, laser processing, chemical or physical etching, and combinations thereof.

The applied metal oxide coating may be continuous or discontinuous on the side of the formed orthodontic appliance, and in some embodiments the coverage in the tooth-like cavities of the shell should be greater than about 70%, greater than 80%, greater than 90%, or greater than 95%, to provide an effective antimicrobial effect. In some embodiments, the metal oxide coating is present in fully continuous layer providing 100% coverage in the tooth-like cavities of the shell.

In another embodiment, the tooth-shaped cavities may be formed in the sheet of polymeric material to form a shell-like orthodontic dental appliance, and then the metal oxide layer may thereafter be applied to overlie all or a desired portion of the cavities. In some embodiments, the metal oxide layer may also be applied on all or a desired portion of an external surface of the dental appliance opposite the teeth-retaining cavities.

In another embodiment, the shell-like orthodontic dental appliance may be formed using a three-dimensional (3D) printing process (e.g. additive manufacturing), such as stereolithography, and then the metal oxide layer may thereafter be applied on an internal surface of the tooth-retaining cavities, or on an external surface, or both.

Application of the metal oxide coating by sputtering, physical vapor deposition, chemical vapor deposition, plasma-enhanced physical vapor deposition, electronic beam deposition, and the like provides a substantially continuous coating that is substantially free of nanoparticles. While not wishing to be bound by any theory, presently available evidence indicates that these deposition techniques, particularly plasma enhanced chemical vapor deposition, in situ modify the surface of the polymeric sheet by a process similar to etching, and can mechanically interlock the deposited metal oxide with the surface of the polymer sheet. Evidence indicates that the metal ions in the metal oxide layer impregnate the surface of the polymeric sheet and form a continuous layer on the surface. This mechanical interlock provides the metal oxide layer with excellent interfacial adhesion to the surface of the polymeric substrate, and provides strong resistance to staining microorganism growth.

In some embodiments, the metal oxide layer 110 is substantially continuous on the surfaces 106, 108 of the shell 102, which in this application means that the metal oxide layer 110 forms a uniform coating on selected areas of (or all) of the surfaces 106, 108. The metal oxide layer 110 has a relatively smooth surface topography, and is substantially free of discrete nanoparticulate islands. In some embodiments, the dimension of the surface area of any discontinuous or discrete coating in either direction is greater than 100 nm, which ensures that the discontinuous or discrete coating is bound very well to the surface of the polymeric substrate.

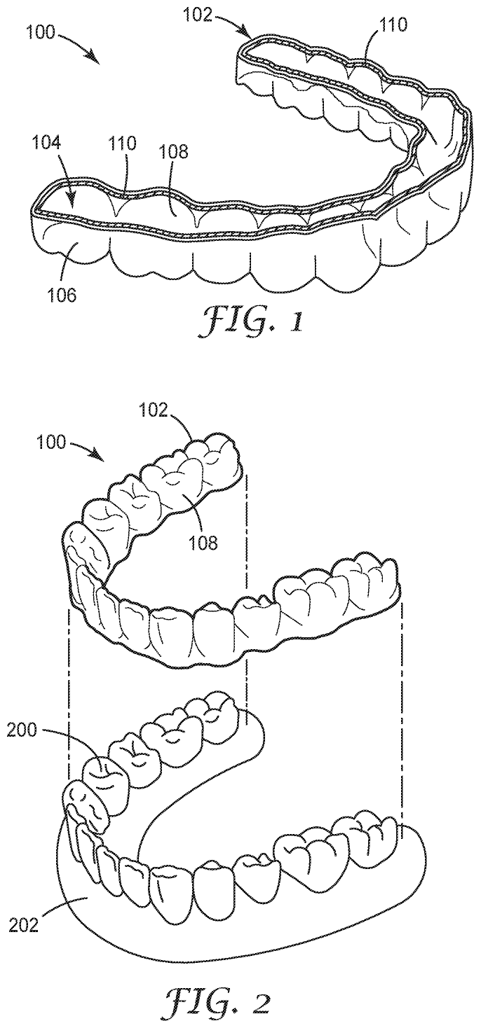

Referring now to FIG. 2, the shell 102 of the orthodontic appliance 100 is an elastic polymeric material that generally conforms to a patient's teeth 200, but that is slightly out of alignment with the patient's initial tooth configuration. In some embodiments, the shell 102 may be one of a group or a series of shells having substantially the same shape or mold, but which are formed from different materials to provide a different stiffness or resilience as need to move the teeth of the patient. In this manner, in one embodiment, a patient or a user may alternately use one of the orthodontic appliances during each treatment stage depending upon the patient's preferred usage time or desired treatment time period for each treatment stage.

No wires or other means may be provided for holding the shell 102 over the teeth 200, but in some embodiments, it may be desirable or necessary to provide individual anchors on teeth with corresponding receptacles or apertures in the shell 102 so that the shell 102 can apply a retentive or other directional orthodontic force on the tooth which would not be possible in the absence of such an anchor.

The shells 102 may be customized, for example, for day time use and night time use, during function or non-function (chewing vs. non-chewing), during social settings (where appearance may be more important) and nonsocial settings (where the aesthetic appearance may not be a significant factor), or based on the patient's desire to accelerate the teeth movement (by optionally using the more stiff appliance for a longer period of time as opposed to the less stiff appliance for each treatment stage).

For example, m one aspect, the patient may be provided with a clear orthodontic appliance that may be primarily used to retain the position of the teeth, and an opaque orthodontic appliance that may be primarily used to move the teeth for each treatment stage. Accordingly, during the day time, in social settings, or otherwise in an environment where the patient is more acutely aware of the physical appearance, the patient may use the clear appliance. Moreover, during the evening or night time, in non-social settings, or otherwise when in an environment where physical appearance is less important, the patient may use the opaque appliance that is configured to apply a different amount of force or otherwise has a stiffer configuration to accelerate the teeth movement during each treatment stage. This approach may be repeated so that each of the pair of appliances are alternately used during each treatment stage.

Referring to FIG. 2, systems and method in accordance with the various embodiments of the present invention include a plurality of incremental position adjustment appliances, each formed from the same or a different material, for each treatment stage of orthodontic treatment. The orthodontic appliances may be configured to incrementally reposition individual teeth 200 in an upper or lower jaw 202 of a patient. In some embodiments, the cavities 104 are configured such that selected teeth will be repositioned, while others of the teeth will be designated as a base or anchor region for holding the repositioning appliance in place as it applies the resilient repositioning force against the tooth or teeth intended to be repositioned.

Placement of the elastic positioner 102 over the teeth 200 applies controlled forces in specific locations to gradually move the teeth into the new configuration. Repetition of this process with successive appliances having different configurations eventually moves a patient's teeth through a series of intermediate configurations to a final desired configuration.

The devices of the present disclosure will now be further described in the following non-limiting examples.

### Examples

### Materials and Methods

### Thermoplastic Films/Trays:

Inventive antimicrobial MOx coatings were deposited on: 1) PETg films; and on 2) PETg aligner trays; using a PVD 75 Integrated Batch Coating System available from Kurt J. Lesker Co., Jefferson Hills, Pa.

In the first case, MOx was coated on a single side of PETg film disks (0.75 mm thick×125 mm diameter) prior to thermoforming into trays with MOx towards the teeth-receiving side of the tray (Type-1). In the second case, inside surface of already prepared aligner tray (thermoformed) was coated with MOx (Type-2).

### MOx Coatings on PETg Substrates Via DC/RF Sputtering:

Metal oxide films were sputtered from a 76.2 mm round metal target in a batch vacuum chamber. The substrate was held in a substrate holder inside the chamber with a sputtering metal target at 228.6 mm distance from the substrate. After the chamber was evacuated to 5×10⁻⁵ torr base pressure, sputtering gases of argon and oxygen were admitted inside the chamber and total pressure of the chamber was adjusted to 3 or 50 millitorr (mT). Sputtering was initiated using a DC or RF power supply at a constant power level for a given time for the desired coating thickness.

Co-sputtering MOx Coatings: Mixture of metal oxides were co-sputtered from two 76.2 mm round metal targets in a batch vacuum chamber. The substrate was held in a substrate holder inside the chamber with two sputtering metal targets located at 228.6 mm distance from the substrate holder. After the chamber was evacuated to 5×10⁻⁵ torr base pressure, sputtering gases of argon and oxygen were admitted inside the chamber and total pressure of the chamber was adjusted to 15 millitorr (mT). Sputtering was initiated using DC power and RF power supplies at two power levels respectively for the two sputtering targets for a given time for the desired coating thickness. MOx deposited on PETg films as well as on aligner trays. Sputtering targets, sputtering method, sputtering conditions, O₂/Ar ratio and light transmission (BYK Haze-Gard) of the coated films are displayed in Table-I.

In the first case, PETg film with MOx coating on one side was thermoformed into a dental aligner tray with MOx towards teeth-receiving side of the tray shell (Type-1). In the second case, an inside surface of already prepared aligner tray (thermoformed) was coated with MOx (Type-2).

### Coating Thickness Measurement Method Description:

The coating rate was pre-determined from the coating thickness using Veeco Dektak profilometer for a coating time of 5 minutes. Kapton tape was applied on and covering a partial area of a glass slide. After coating by deposition, the tape was removed from the glass, and the coating thickness was determined from the step change obtained from the scanning by the stylus probe of Veeco Dektak contact profilometer. The desired coating thickness on the substrate is coated at a given coating time according to the pre-determined coating rate.

TABLE 1
Sputtering conditions used for producing MOx coatings

| | Substrate | | RF | DC | RF | | O2/Ar | Coating |
|---|---|---|---|---|---|---|---|---|
| Sample ID | PETg | DC Target | Target | Power | Power | Pressure | Ratio | Time |
| OCSD-01 | Film | N/A | Ag | N/A | 200 W | 3 mT | 0.45 | 15 sec |
| OCSD-02 | Film | Zn | N/A | 500 W | N/A | 3 mT | 0.25 | 5 min |
| OCSD-03 | Film | 50/35/15 | N/A | 150 W | N/A | 46.2 mT | 0.36 | 50 sec |
| | | Ag/Cu/Zn | | | | | | |
| | | alloy | | | | | | |
| PVD75-371 | Film | Al-doped | Ag | 100 W | 25 W | 15 mT | 0 | 5 min |
| | | ZnO | | | | | | |
| PVD75-372 | Film | Al-doped | Ag | 100 W | 25 W | 15 mT | 0.05 | 5 min |
| | | ZnO | | | | | | |
| PVD75-373 | Film | Ti | Ag | 200 W | 20 W | 15 mT | 0.13 | 5 min |
| PVD75-374 | Film | Ti | Ag | 200 W | 20 W | 15 mT | 0.065 | 5 min |
| PVD75-391 | Tray | Ti | Ag | 200 W | 20 W | 15 mT | 0.065 | 5 min |
| PVD75-392 | Tray | Ti | Ag | 200 W | 40 W | 15 mT | 0.065 | 5 min |
| PVD75-393 | Tray | Ti | Ag | 200 W | 80 W | 15 mT | 0.065 | 5 min |
| PVD75-395 | Tray | Al-doped | Ag | 100 W | 25 W | 15 mT | 0 | 5 min |
| | | ZnO | | | | | | |
| PVD75-396 | Tray | Al-doped | Ag | 100 W | 50 W | 15 mT | 0 | 5 min |
| | | ZnO | | | | | | |

TABLE 2
Examples 1-12 Measured Coating Thickness and
Light Transmission %

| | | Sub- | | | | |
|---|---|---|---|---|---|---|
| | | strate | | RF | Coating | |
| Example | Sample ID | PETg | DC Target | Target | Thickness | % T |
| Control | No Coating | Film | N/A | N/A | 0 | 91.0 |
| Ex. 1 | OCSD-01 | Film | N/A | Ag | 5 nm | 68.0 |
| Ex. 2 | OCSD-02 | Film | Zn | N/A | 50 nm | 81.0 |
| Ex. 3 | OCSD-03 | Film | 50/35/15 | N/A | 10 nm | 84.6 |
| | | | Ag/Cu/Zn | | | |
| | | | alloy | | | |
| Ex. 4 | PVD75-371 | Film | Al-doped | Ag | 36 nm | 77.0 |
| | | | ZnO | | | |
| Ex. 5 | PVD75-372 | Film | Al-doped | Ag | 30 nm | 88.0 |
| | | | ZnO | | | |
| Ex. 6 | PVD75-373 | Film | Ti | Ag | 85 nm | 90.0 |
| Ex. 7 | PVD75-374 | Film | Ti | Ag | 100 nm | 83.5 |
| Ex. 8 | PVD75-391 | Tray | Ti | Ag | 100 nm | N/A |
| Ex. 9 | PVD75-392 | Tray | Ti | Ag | NM | N/A |
| Ex. 10 | PVD75-393 | Tray | Ti | Ag | NM | N/A |
| Ex. 11 | PVD75-395 | Tray | Al-doped | Ag | 36 nm | N/A |
| | | | ZnO | | | |
| Ex. 12 | PVD75-396 | Tray | Al-doped | Ag | NM | N/A |
| | | | ZnO | | | |

“NM” = Not Measured

### Antimicrobial Kill Properties of MOx Coatings on PETg:

ISO test method ISO 22196:2011, “Measurement of antibacterial activity on plastics and other non-porous surfaces,” with appropriate modifications of the test method to accommodate the test materials was used for evaluating the antibacterial propensity of MOx coatings on PETg. Coated PETg films and one uncoated PETg film were cut into square coupons (2.5 cm×2.5 cm, n=2) for antimicrobial activity against microorganisms such as Staphylococcus aureus (ATCC 6538) and Streptococcus mutans (ATCC 27352). Inoculums of S. aureus and S. mutans were prepared in phosphate buffer and artificial saliva, respectively. The composition of the artificial saliva was as following (g/L): gastric mucin, Sigma Porcine stomach mucin type III, 2.2; NaCl, 0.381, CaCl₂.2H₂O, 0.213, KH₂PO₄, 0.738, and KCl, 1.114. Each inoculum (150 □l) was spread over the MOx coated surface of the coupon and incubated for 24 hours at 37 C. After incubation, samples were neutralized in DE neutralizing broth and plated on AC petrifilm for S. aureus and blood agar for S. mutans.

### Antimicrobial Kill Results:

Examples 1-7 in Table 3 below represent MOx compositions deposited on PETg disks (n=4). Their visible light transmission (% T) of each disk was measured. One coated disk was used for determining 24-hr contact antimicrobial kill activity per modified ISO 22196:2011. Table 3 shows 24-hr contact kill activity of different coatings (Control and Examples 1-7) against S. aureus and S. mutans. As can be seen from the data, except for ZnO against S. mutans all other coatings produced approximately a 4-log reduction in bacteria count compared to the control.

### Aesthetic Appearance of Type-1 and Type-2 Prepared Trays:

Examples 1-7 in Table 4 below represent MOx compositions deposited on PETg disks which were then thermoformed into (Type-1) orthodontic aligner trays with MOx inside the tray (teeth receiving shell cavity).

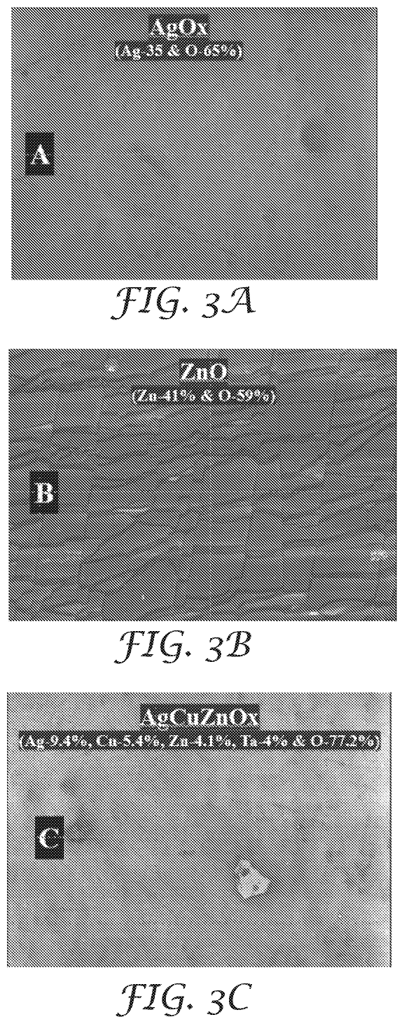

A Hitachi TM3000 SEM equipped with Bruker Quantax 70 Energy-Dispersive Spectrometry was used to examine the morphology and composition of MOx coatings on PETg after being subjected to thermoforming. FIGS. 3A-3C shows the SEM high magnification images along with their compositions of A) AgOx, B) ZnO and C) AgCuZnOx coatings described in Examples-1-3. The figure shows that the coatings were continuously uniform versus discrete nanoparticulate islands.

Examples 8-12 in Table 4 below represent MOx compositions sputter deposited onto the inside of pre-formed orthodontic PETg aligner trays (Type-2 Trays). The MOx coated PETg aligner trays were each placed on a typodont (a model of the oral cavity including teeth, gums, and palate) and visually assessed for aesthetic appearance, color and clarity. Example 12 (Ag-AZO) coating was deemed only marginally acceptable in appearance because of its yellow tint when compared to other coatings as compared to uncoated PETg trays. The AgOx coating of Example 1 was deemed only marginally acceptable in appearance because of its yellow tint and low light transmittivity, when compared to other coatings (such as ZnO and AgCuZnOx, of Examples 2 and 3, respectively), and as compared against uncoated PETg tray (Control). Examples that were rated “Excellent” in appearance were substantially color-free and highly transparent.

TABLE 3
Antimicrobial Kill Results for Antimicrobial
MOx coatings used for orthodontic trays

| | | | | S. aureus | S. mutans |
|---|---|---|---|---|---|
| | | Substrate | | Kill | Kill |
| Example | Sample ID | PETg | % T | (log) | (log) |
| Control | No Coating | Film | 91.0 | −5.5 | −4.6 |
| Ex. 1 | OCSD-01 | Film | 68.0 | −0.84 | −0.84 |
| Ex. 2 | OCSD-02 | Film | 81.0 | −0.84 | −4.32 |
| Ex. 3 | OCSD-03 | Film | 84.6 | −0.84 | −0.84 |
| Ex. 4 | PVD75-371 | Film | 77.0 | −0.84 | −0.84 |
| Ex. 5 | PVD75-372 | Film | 88.0 | −0.84 | −0.84 |
| Ex. 6 | PVD75-373 | Film | 90.0 | −0.84 | −0.84 |
| Ex. 7 | PVD75-374 | Film | 83.5 | −0.84 | −0.84 |

TABLE 4
Aesthetic Appearance of Type 1 and Type 2 Trays coated with
Antimicrobial MOxcoatings

| | | Coated | | | | Tray |
|---|---|---|---|---|---|---|
| | | Sub- | | | | Appearance |
| | | strate | Film | Tray | Coating | on |
| Example | Sample ID | PETg | % T | Type | Thickness | Typodont |
| Control | No Coating | Film | 91 | Type 1 | 0 | Excellent |
| Ex. 1 | OCSD-01 | Film | 68.0 | Type 1 | 5 nm | Marginally |
| | | | | | | Acceptable |
| Ex. 2 | OCSD-02 | Film | 81.0 | Type 1 | 50 nm | Excellent |
| Ex. 3 | OCSD-03 | Film | 84.6 | Type 1 | 10 nm | Excellent |
| Ex. 4 | PVD75-371 | Film | 77.0 | Type 1 | 36 nm | Excellent |
| Ex. 5 | PVD75-372 | Film | 88.0 | Type 1 | 30 nm | Excellent |
| Ex. 6 | PVD75-373 | Film | 90.0 | Type 1 | 85 nm | Excellent |
| Ex. 7 | PVD75-374 | Film | 83.5 | Type 1 | 100 nm | Excellent |
| Ex. 8 | PVD75-391 | Tray | N/A | Type 2 | 100 nm | Excellent |
| Ex. 9 | PVD75-392 | Tray | N/A | Type 2 | NM | Excellent |
| Ex. 10 | PVD75-393 | Tray | N/A | Type 2 | NM | Excellent |
| Ex. 11 | PVD75-395 | Tray | N/A | Type 2 | 36 nm | Excellent |
| Ex. 12 | PVD75-396 | Tray | N/A | Type 2 | NM | Marginally |
| | | | | | | Acceptable |

“NM” = Not Measured

Various embodiments of the invention have been described. These and other embodiments are within the scope of the following claims.

1. A dental appliance, comprising:
a polymeric shell with a first major surface comprising a plurality of cavities for receiving one or more teeth; and
a layer of a metal oxide MOx on the first major surface.

2. The dental appliance of claim 1, wherein the layer of the metal oxide comprises at least one metal oxide chosen from AgOx, ZnOx, CuOx, TiOx, AlOx and mixtures and alloys thereof.

3. The dental appliance of claim 1, wherein the metal oxide is chosen from AgCuZnOx, Ag doped ZnOx, Ag doped AZO, Ag doped TiO₂, Al doped ZnO, and TiOx.

4. The dental appliance of claim 1, wherein the dental appliance transmits at least 60% of incident light with a wavelength of about 400-750 nm.

5-6. (canceled)

7. The dental appliance of claim 1, wherein the layer of the metal oxide has a thickness of about 1 nm to about 200 nm.

8-9. (canceled)

10. The dental appliance of claim 1, wherein the layer of the metal oxide is substantially transparent to visible light with a wavelength of 400-750 nm.

11-13. (canceled)

14. The dental appliance of claim 1, wherein the layer of the metal oxide exhibits at least a 1-log microbial reduction against S. aureus and S. mutans following 24 hour contact.

15-16. (canceled)

17. A method of making a dental appliance, the method comprising:
applying a layer of a transparent metal oxide MOx on at least one major surface of a substantially flat sheet of a polymeric material; and
forming a plurality of cavities in the polymeric material to form the dental appliance, wherein the cavities are configured to receive one or more teeth.

18. (canceled)

19. The method of claim 17, wherein the layer of the transparent metal oxide is applied by one of sputtering, physical vapor deposition, chemical vapor deposition, and electronic beam deposition.

20. The method of claim 19, wherein the layer of the transparent metal oxide is applied by plasma enhanced chemical vapor deposition.

21-25. (canceled)

26. The method of claim 17, wherein the layer of the transparent metal oxide has a thickness of about 1 nm to about 200 nm.

27-28. (canceled)

29. The method of claim 17, wherein the cavities in the polymeric material are thermally formed.

30-32. (canceled)

33. A method of making a dental appliance, the method comprising:
forming a polymeric shell comprising a plurality of cavities in a first major surface thereof, wherein the cavities are configured to receive one or more teeth; and
applying a layer of a transparent metal oxide MOx on the first major surface of the polymeric shell to form the dental appliance.

34-35. (canceled)

36. The method of claim 33, wherein the layer of the transparent metal oxide is applied by one of sputtering, physical vapor deposition, chemical vapor deposition, and electronic beam deposition.

37. The method of claim 36, wherein the layer of the transparent metal oxide is applied by plasma enhanced chemical vapor deposition.

38-41. (canceled)

42. The method of claim 33, wherein the layer of the transparent metal oxide has a thickness of about 1 nm to about 200 nm.

43-44. (canceled)

45. The method of claim 33, wherein the layer of the transparent metal oxide is substantially continuous on the first major surface.

46. The method of claim 33, wherein the layer of the transparent metal oxide overlies at least 95% of the first major surface.

47-49. (canceled)

50. The dental appliance of claim 1, wherein the metal oxide MOx penetrates below the first major surface.

51-67. (canceled)

68. A method of orthodontic treatment, comprising:
positioning a dental appliance of claim 1 around one or more teeth.

69-71. (canceled)
